(19) United States
(12) Patent Application Publication
(10) Pub. No.: US 2024/0120814 A1
(43) Pub. Date: Apr. 11, 2024

(54) REDUCING ELECTRIC DISCHARGE MACHINING CURRENTS IN ELECTRIC MOTORS

(71) Applicant: GM GLOBAL TECHNOLOGY OPERATIONS LLC, Detroit, MI (US)

(72) Inventors: William T. Ivan, Shelby Township, MI (US); Alireza Fatemi, Canton, MI (US); Margarita P. Thompson, Livonia, MI (US)

(73) Assignee: GM GLOBAL TECHNOLOGY OPERATIONS LLC, Detroit, MI (US)

(21) Appl. No.: 17/960,164

(22) Filed: Oct. 5, 2022

(51) Int. Cl. H02K 13/10; H02K 1/12; H02K 1/22; H02K 5/04; H02K 7/00; H02K 7/08

(52) U.S. Cl. CPC H02K 13/10; H02K 1/12; H02K 1/22; H02K 5/04; H02K 7/003; H02K 7/08

(57) ABSTRACT

Presented are electric motors and apparatuses thereof for discharging an electric charge buildup on the rotor. In an embodiment, an electric motor apparatus includes a case, a stator arranged within the case, a rotor, a motor shaft extending longitudinally through the rotor to include an axial end, a grounding brush having an outer surface and an elliptical surface, and a spring including one portion maintaining slidable contact with the case and another portion coupled to an outer surface of the brush, the elliptical surface attached to the axial end of the motor shaft for causing a current flow via the brush through the case, which can act as system ground, for discharging an electric charge buildup on the stator due to a parasitic capacitance between the stator and rotor.

### INTRODUCTION

The present disclosure relates generally to electric motors. More specifically, aspects of this disclosure relate to apparatuses for reducing Electric Discharge Machining (EDM) currents in electric motors in vehicles and other machines.

Electric vehicles are becoming increasingly popular, and consequently increasingly prevalent, in the inventory of modern automobile manufacturers. Current production electric vehicles, including both full electric and hybrid vehicles, may be equipped with a powertrain that operates to propel the vehicle via these electric motors. Different types of electric motors have been developed for use in such vehicles. Existing electric motors commonly employ a bearing system used to maintain stable rotation of the motor shaft in an AC induction motor and other motor types, which in turn can be used to rotate a wheel or intermediary structure for powering the vehicle.

Existing electric vehicles and their hybrid counterparts have shortcomings. The bearings used in most types of electric motors are subject to damage due to electrical arcs created by virtue of parasitic charge buildup on the rotor within the drive unit case in which the motor is housed. The charge buildup can be due to the parasitic capacitance between the stator and rotor core, with the gap therebetween acting as a dielectric. The accumulation of charge eventually can cause leakage current to discharge through the motor shaft and the race, which leads to electrical arcs through the bearings. These arcs can create pits and other permanent damage in the bearings.

To ameliorate this problem, manufacturers conventionally couple a conductive spring-loaded brush to the motor shaft. During operation of the motor, the spring presses into the inner drive unit case or other system ground to discharge the parasitic voltage. The continued radial force of the spring on the motor shaft tends to wear down the shaft surface and brush, often causing visible wear lines across the motor shaft's diameter. Permanent damage can thereafter result.

### SUMMARY

Presented herein are electric motors for use in electric vehicles and other machinery that obviate the above-referenced problems. As noted, conventional solutions common to numerous types of electric motors involve the manufacturer appending a spring onto a radial portion of the motor shaft. The spring is geometrical-shaped to press against a vehicle or system ground during rotation of the motor shaft, such as an interior of the drive unit case, to provide a low resistance current path to ground, and thereby avoid the damaging electric arcs that may pass through the lubricant of the bearings. The collective electrical resistance of the brush, spring and motor shaft is configured to provide a lower resistance path to ground than a path through the race, ball bearings and lubricate film.

One unintended consequence of this solution may occur quickly over time as the brush continues to rotate at the speed of the motor shaft. In so doing, a large centripetal force is asserted inward which increases with the spring rotational speed, which translates to a heavy load on the motor shaft particularly when the spring is spinning at a fast rate. This heavy load may invariably result in premature wear to, and ultimate failure of, the electric motor resulting from damage to the motor shaft. In short, the radial load induced on the rotating shaft by virtue of the spring tends to quickly wear the motor shaft down. The wear may be initially evidenced by wear lines in the shaft's diameter due to contact force abrasion from the brush's radial load. This wear may quickly escalate to radial cracks, generate debris, and ultimately permanent damage to the shaft and bearing system. By the same token, removing the spring tends to redirect the subject parasitic current discharges once again through the bearings, at which point the electrical arcs may quickly result in irreparable damage to the bearing system.

Attempts at fixing this problem have been made without apparent success. The inventor is aware of one electric motor implementation in which a conductive needle is placed at the center of the motor shaft to redirect the current to a spinning spring to ground. However, in addition to acting as a substantial bottleneck to the minimum possible electrical resistance that may in practice be obtained using the narrow needle—which may result in electrical arcs across the bearings despite the needle and spring—the needle is narrow and necessarily brittle to not bend. The needle is consequently easily breakable, especially at the speed of many modern electric motors, which may destroy the motor. For this reason, it is not surprising that most other manufacturers that rely on a spinning spring as an attempted solution connect the spring via a structure that radially loads the motor shaft to adequately support the spring while enabling a low resistance path. This proposed solution, however, in turn results in quick wear and inevitable damage to the shaft for the reasons above.

Aspects of this disclosure are accordingly directed to electric motor configurations for providing a low resistance current path to avoid electrical arcing across the bearings while minimizing or altogether eliminating the above-referenced wear on the motor shaft. In an example, an apparatus is presented for preventing electric charge buildup on the rotor core due to the parasitic capacitance between the stator and rotor core. The electric motor apparatus includes a case, a stator within a first inner surface of the case, and a rotor within the stator and configured to rotate relative to the stator. The electric motor apparatus includes a motor shaft protruding longitudinally through the rotor to include an axial end. A grounding brush has an outer surface opposing an at least partly elliptical surface. Also, a spring may include a first portion to maintain slidable contact with a second inner surface of the case and a second portion coupled to an outer surface of the brush. The at least partly elliptical surface of the brush is attached to the axial end of the motor shaft for causing a current flow via the brush to the second inner surface of the case for discharging an electric charge buildup on the stator.

Because the load on the motor shaft is axial in the subject matter herein, rather than predominantly radial as in conventional solutions, the incidents of premature damage to the motor shaft may be significantly reduced if not altogether eliminated. Meanwhile, the low-resistance current path created selectively from the rotor core via the motor shaft and grounding brush to the second inner surface of the case protects against electrical arcs from compromising the bearing system as the low-resistance path maintains the first and second inner surface of the case at the same ground potential.

In another aspect of the disclosure, an electric motor for a vehicle is presented. The electric motor includes a drive unit case, and a stator arranged within the drive unit case. A rotor is within the stator. A motor shaft extends longitudinally through the rotor core. The electric motor further includes an anti-arc system. The anti-arc system includes a conducting grounding brush and a spring. The spring has a first portion configured to maintain contact with a system or vehicle ground, and a second portion connected to the grounding brush. The grounding brush further includes an elliptical-shaped surface coupled to an axial end surface 423 of the motor shaft to discharge an electric charge buildup on the rotor core.

In still another aspect of the disclosure, an electric motor includes a case, and a stator arranged within the drive unit case. A rotor is at least partly within the stator. A motor shaft extends longitudinally through the rotor. An anti-arc system includes a conducting grounding brush and a spring. The spring has a first portion configured to maintain contact with an interior of the case during motor operation. The spring also has a second portion connected to the grounding brush. The grounding brush includes an elliptical-shaped surface having a center portion coupled outwardly to an axial end surface of the motor shaft.

Additional aspects of this disclosure are directed to electric motors using dedicated low resistance paths for leakage current flow and equalization of voltage across the entire drive unit case or other system ground without an appreciable radial load placed on the motor shaft. As used herein unless otherwise evident from the context, the terms “vehicle” and “electric vehicle” may be used interchangeably and synonymously to include any relevant electric or hybrid vehicle platform, such as passenger vehicles (REV, FEV, fuel cell, fully and partially autonomous, etc.), commercial vehicles, industrial vehicles, tracked vehicles, off-road and all-terrain vehicles (ATV), motorcycles, farm equipment, watercraft, aircraft, etc. In an example, a motor vehicle includes a vehicle body with a passenger compartment, multiple drive wheels rotatably mounted to the vehicle body (e.g., via corner modules coupled to a unibody or body-on-frame chassis), and other standard original equipment. For electric-drive vehicle applications, one or more electric traction motors operate alone (e.g., for FEV powertrains) or in conjunction with an internal combustion engine assembly (e.g., for HEV powertrains) to selectively drive one or more of the road wheels to propel the vehicle. Where an induction motor or synchronous reluctance motor is used or an alternating current is otherwise required for engine operation, a rechargeable traction battery pack, for example, may be mounted onto the vehicle body and may be operable to power the traction motor(s) using a traction power inverter module (TPIM).

The above Summary is not intended to represent every embodiment or every aspect of the present disclosure. Rather, the foregoing summary merely provides an exemplification of some of the novel concepts and features set forth herein. The above features and advantages, and other features and attendant advantages of this disclosure, will be readily apparent from the following detailed description of illustrated examples and representative modes for carrying out the present disclosure when taken in connection with the accompanying drawings and the appended claims. Moreover, this disclosure expressly includes any and all combinations and sub combinations of the elements and features presented above and below.

### BRIEF DESCRIPTION OF THE DRAWINGS

FIG. 1 is a partially schematic, side-view illustration of a representative motor vehicle with an electrified powertrain, a traction battery pack, and a network of in-vehicle controllers, sensing devices, and communication devices according to aspects of the disclosed concepts.

FIG. 2 is a cross-sectional side illustration of an electric motor having a spring configured to contact a radial portion of the motor shaft during operation.

FIG. 3 is a side, cross-sectional illustration of an example electric motor having a spring coupled to an interior of the case and connected to a radial portion of the motor shaft.

FIG. 4 is a side, cross-sectional illustration of an example electric motor having a grounding brush used for coupling a spring to an axial portion of the motor shaft and having an elliptical/spherical half-shape to restrict radial forces on the motor shaft.

The present disclosure is amenable to various modifications and alternative forms, and some representative embodiments are shown by way of example in the drawings and will be described in detail herein. It should be understood, however, that the novel aspects of this disclosure are not limited to the forms illustrated in the above-enumerated drawings. Rather, the disclosure is to cover all modifications, equivalents, combinations, sub combinations, permutations, groupings, and alternatives falling within the scope of this disclosure as encompassed, for example, by the appended claims.

### DETAILED DESCRIPTION

This disclosure is susceptible of embodiment in many different forms. Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Introduction, Summary, and Detailed Description sections, but not explicitly set forth in the claims, should not be incorporated into the claims, singly or collectively, by implication, inference or otherwise.

For purposes of the present detailed description, unless specifically disclaimed: the singular includes the plural and vice versa; the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein in the sense of “at, near, or nearly at,” or “within 0-5% of,” or “within acceptable manufacturing tolerances,” or any logical combination thereof, for example. Lastly, directional adjectives and adverbs, such as fore, aft, inboard, outboard, starboard, port, vertical, horizontal, upward, downward, front, back, left, right, etc., may be with respect to a motor vehicle, such as a forward driving direction of a motor vehicle when the vehicle is operatively oriented on a horizontal driving surface.

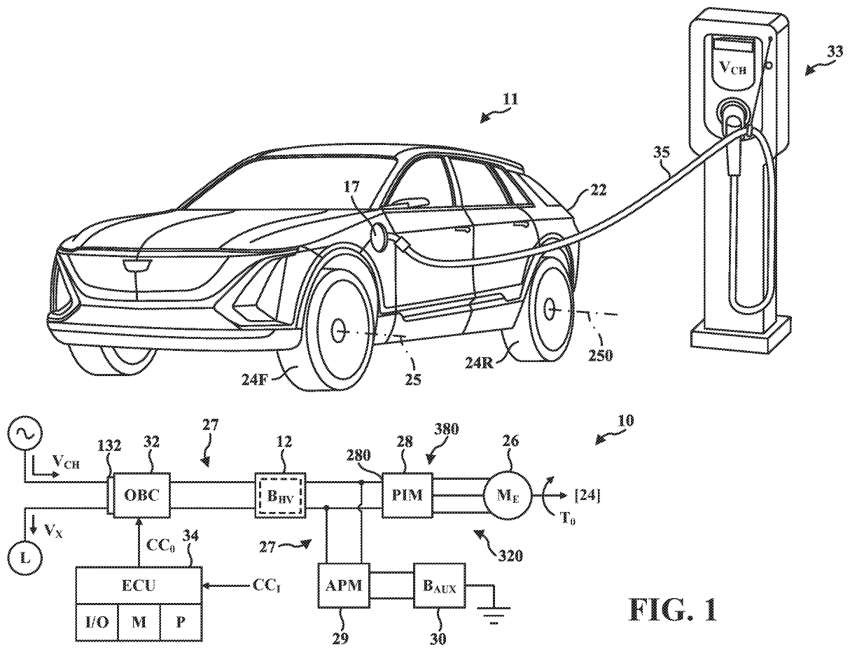

Referring to the drawings, wherein like reference numbers refer to like features throughout the several views, FIG. 1 depicts an electrified powertrain system 10 having a high-voltage battery pack (B_{HV}) 12. In a non-limiting example, the battery pack 12 may be embodied as a high-capacity battery having a voltage capability of about 400-800 volts or more, with the actual voltage capability of the battery pack 12 provided based on a desired operating range, gross weight, and power rating of a load connected to the battery pack 12. In a possible construction, the battery pack 12 may be a propulsion battery pack generally composed of an array of lithium-ion or lithium-ion polymer rechargeable electrochemical battery cells. The present teachings may also be applied to other energy storage systems including prismatic battery cells, pouch-style battery cells in possible configurations. In other configurations, the battery back may be accompanied by a fuel tank where a hybrid vehicle is involved. While the battery pack 12 is described as an array of battery cells, in other implementations a single battery may be used. A specific number of cells or type of stored chemical energy used for conversion to electricity in an electric motor is not required, and many options may be available without departing from the spirit and scope of the present disclosure.

Referring still to FIG. 1, in a representative use case the electrified powertrain system 10 may be used as part of a motor vehicle 11 or another mobile system. As shown, the motor vehicle 11 may be embodied as a battery electric vehicle, with the present teachings also being extendable to plug-in hybrid electric vehicles. Alternatively, the electrified powertrain system 10 may be used as part of another mobile system such as, but not limited to, a rail vehicle, aircraft, marine vessel, robot, farm equipment, etc. Likewise, the electrified powertrain system 10 may be stationary, such as in the case of a powerplant, hoist, drive belt, or conveyor system. Therefore, the electrified powertrain system 10 in the representative vehicular embodiment of FIG. 1 is intended to be illustrative of the present teachings and not limiting thereof.

The motor vehicle 11 shown in FIG. 1 includes a vehicle body 22 and road wheels 24F and 24R, with “F” and “R” indicating the respective front and rear positions. The road wheels 24F and 24R rotate about respective axes 25 and 250, with the road wheels 24F, the road wheels 24R, or both being powered by output torque (arrow T_{O}) from a rotary electric machine (M_{E}) 26 of the electrified powertrain system 10 as indicated by arrow [24]. The road wheels 24F and 24R thus represent a mechanical load in this embodiment, with other possible mechanical loads being possible in different host systems. To that end, the electrified powertrain system 10 may include a power inverter module (PIM) 28 and the high-voltage battery pack 12, e.g., a multi-cell lithium-ion propulsion battery or a battery having another application-suitable chemistry, both of which are arranged on a high-voltage DC bus 27. When a rotary electric motor or induction motor is used for propelling the vehicle forward or for acting as a generator, the DC current from the battery may be changed to an AC signal.

In certain implementations where other types of motors are used (such as a DC brushless motor), the inverter functionality of PIM 28 may not be needed, and the DC current can be supplied directly or after being adjusted as suitable to the wires associated with the M_{E} 26. Otherwise, as appreciated in the art, the PIM 28 includes a DC side 280 and an alternating current (AC) side 380, with the latter being connected to individual phase windings (not shown) of the rotary electric machine 26 when the rotary electric machine 26 is configured as a polyphase rotary electric machine in the form of a propulsion or traction motor as shown.

The battery pack 12 of FIG. 1 in turn is connected to the DC side 280 of the PIM 28, such that a battery voltage from the battery pack 12 is provided to the PIM 28 during propulsion modes of the motor vehicle 11. The PIM 28, or more precisely a set of semiconductor switches (not shown) residing therein, are controlled via pulse width modulation, pulse density modulation, or other suitable switching control techniques to invert a DC input voltage on the DC bus 27 into an AC output voltage suitable for energizing a high-voltage AC bus 320. High-speed switching of the resident semiconductor switches of the PIM 28 thus ultimately energizes the rotary electric machine 26 to thereby cause the rotary electric machine 26 to deliver the output torque (arrow T_{O}) as a motor drive torque to one or more of the road wheels 24F and/or 24R in the illustrated embodiment of FIG. 1, or to another coupled mechanical load in other implementations.

Electrical components of the electrified powertrain system 10 may also include an accessory power module (APM) 29 and an auxiliary battery (B_{AUX}) 30. The APM 29 is configured as a DC-DC converter that is connected to the DC bus 27, as appreciated in the art. In operation, the APM 29 is capable, via internal switching and voltage transformation, of reducing a voltage level on the DC bus 27 to a lower level suitable for charging the auxiliary battery 30 and/or supplying low-voltage power to one or more accessories (not shown) such as lights, displays, etc. Thus, “high-voltage” refers to voltage levels well in excess of typical 12-15V low/auxiliary voltage levels, with 400V or more being an exemplary high-voltage level in some embodiments of the battery pack 12.

In some configurations, the electrified powertrain system 10 of FIG. 1 may include an on-board charger (OBC) 32 that is selectively connectable to an offboard charging station 33 via an input/output (I/O) block 132 during a charging mode during which the battery pack 12 is recharged by an AC charging voltage (V_{CH}) from the offboard charging station 33. The I/O block 132 is connectable to a charging port 17 on the vehicle body 22. For instance, a charging cable 35 may be connected to the charging port 17, e.g., via an SAE J1772 connection. The electrified powertrain system 10 may also be configured to selectively receive a DC charging voltage in one or more embodiments as appreciated in the art, in which case the OBC 32 would be selectively bypassed using circuitry (not shown) that is not otherwise germane to the present disclosure. The OBC 32 could operate in different modes, including a charging mode during which the OBC 32 receives the AC charging voltage (V_{CH}) from the offboard charging station 33 to recharge the battery pack 12, and a discharging mode, represented by arrow V_{X}, during which the OBC 32 offloads power from the battery pack 12 to an external AC electrical load (L). In this manner, the OBC 32 may embody a bidirectional charger.

Referring again to FIG. 1, the electrified powertrain system 10 may also include an electronic control unit (ECU) 34. The ECU 34 is operable for regulating ongoing operation of the electrified powertrain system 10 via transmission of electronic control signals (arrow CC_{O}). The ECU 34 does so in response to electronic input signals (arrow CC_{I}). Such input signals (arrow CC_{I}) may be actively communicated or passively detected in different embodiments, such that the ECU 34 is operable for determining a particular mode of operation. In response, the ECU 34 controls operation of the electrified powertrain system 10.

To that end, the ECU 34 may be equipped with one or more processors (P), e.g., logic circuits, combinational logic circuit(s), Application Specific Integrated Circuit(s) (ASIC), electronic circuit(s), central processing unit(s), semiconductor IC devices, etc., as well as input/output (I/O) circuit(s), appropriate signal conditioning and buffer circuitry, and other components such as a high-speed clock to provide the described functionality. The ECU 34 also includes an associated computer-readable storage medium, i.e., memory (M) inclusive of read only, programmable read only, random access, a hard drive, etc., whether resident, remote or a combination of both. Control routines are executed by the processor to monitor relevant inputs from sensing devices and other networked control modules (not shown), and to execute control and diagnostic routines to govern operation of the electrified powertrain system 10.

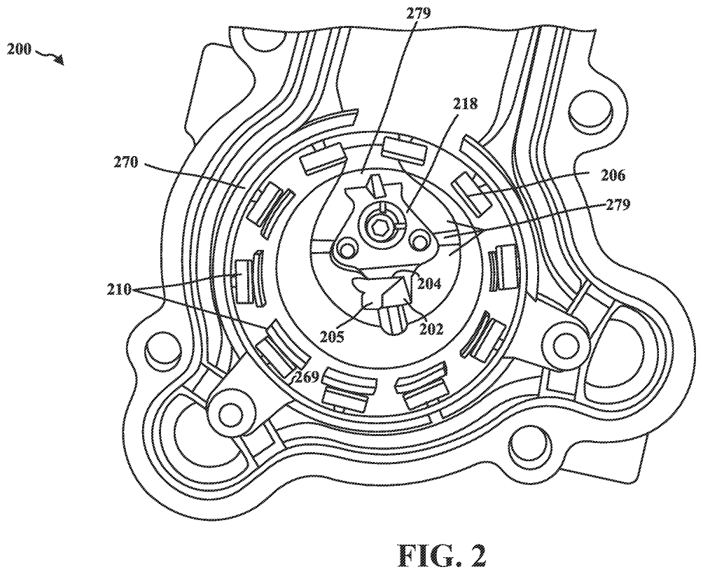

FIG. 2 is a cross-sectional side illustration of an electric motor 200 having a spring 202 configured to contact a radial portion of the motor shaft (not shown). For ease of illustration, a side portion of the electric motor 200 is cut away. A drive unit case 270 encases and surrounds the electric motor 200. The electric motor 200 in this example includes an inner surface 269 between the stator 210 and the case 270.

Depending on the motor type and geometry, the rotor may include windings and/or poles which, for simplicity, are not explicitly detailed and generally may occupy portions of region within the stator 210. Depending on the motor architecture, the stator 210 may additionally or alternatively include a plurality of outcropping salient poles, each of which may include a plurality of windings of insulated coil (not shown). The stator 210 remains stationary as the rotor portion of the motor rotates. The electric motor 200 may be an AC induction, synchronous reluctance or switched reluctance motor, or other viable type of electric motor.

The motor includes a spring 202. The spring includes a tip end 205, and an edge 204, which is jutting out of the picture, generally orthogonal to a plane of the figure. The edge 204 of the spring 202 contacts a radial portion of a motor shaft. The spring 202 further includes a portion 218, which is the part of the spring that is mounted to the back casting, or other inner surface 279 of the spring. Together, the inner surface 269 along with the other inner surface 279 form the inner portion of the case 270.

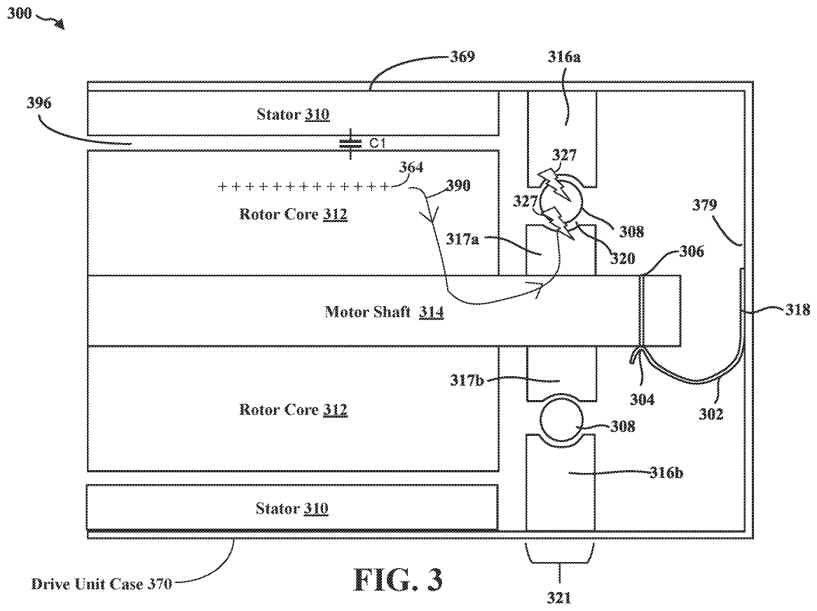

FIG. 3 is a side, cross-sectional illustration of an electric motor 300 having a spring coupled to an interior of the case and connected to a radial portion of the motor shaft. For visual context, the motor is conceptually sliced in half so that the interior of the motor can be easily viewed. In practice, the motor 300 may be another kind of electric motor and need not be limited to a particular electric motor type. For example, the motor may be an alternating-current (AC) induction motor, a switched or synchronous reluctance motor, another synchronous motor, or the like. The motor may have another number of poles, slots, and/or phases, as applicable and depending again on the implementation.

The electric motor 300 of FIG. 3 includes a drive unit case 370, sometimes referred to herein as a “case” in part because the case 370 need not necessarily be limited to housing the drive unit in some configurations, or to a specific device or set of devices. An inner surface 369 of the case 370 is shown as coupled to an outer portion of the stator. In some configurations, the stator 310 may be coupled directly to the inner surface 369. In other configurations, the stator 310 may be proximate or adjacent the inner surface and connected to the case 370 using different means, if at all.

Part or all of the drive unit case 370 may be conductive in order to provide the electric motor 300 with a path to ground as described further herein. In other implementations, the electric motor 300 may rely on another system or vehicle ground. Surrounding a periphery of the electric motor is a stator 310, of which a portion is shown in the cut-off view of FIG. 3. Typically extending within (or at least in partly within) the stator 310 is a rotor core 312. As in FIG. 2, while some embodiments of the rotor include poles, windings, etc., only the rotor core 312 is shown in this illustration to avoid unduly obscuring concepts of the present disclosure.

Depending on the style of electric motor 300, either the stator 310 or the rotor core 312 may include a plurality of protrusions or indentions that incorporate windings for passing current. In an AC induction motor or a synchronous reluctance synchronous motor, for example, the stator 310 may have a plurality of protrusions (not shown) acting as salient poles. The poles may form a corresponding plurality of slots around the circumference of an inner portion of the stator 310. The protrusions may incorporate respective windings arranged using a dedicated number of phases and magnetic poles to generate a rotating magnetic field (RMF). The rotor core 312 may have a corresponding unique geometry (omitted for simplicity as noted) for enabling, in the case of an example AC induction motor, a corresponding variable current to be generated in the rotor core 312. This corresponding variable current may in turn induce its own magnetic field which opposes the RMF of the stator. The rotor core 312 can rotate as a result of the opposing torque caused by the respective fields.

In other configurations involving synchronous reluctance motors, the rotor core 312 need not generate a current, but may instead have a predetermined number of salient poles that tend to cause the rotor core 312 to align with corresponding poles on the stator 310 and thereby minimize reluctance. This operating principle can in turn be used to maintain a synchronous rotation of the rotor core 312. In other implementations, the rotor core 312 may include a permanent magnet or ferromagnetic material for facilitating the interaction of the respective magnetic fields or currents depending again on the operating principle of the electric motor 300. For purposes of this disclosure, as noted above, this motor may be another suitable type used in electric vehicle (EV) or similar applications.

The motor 300 may further include a motor shaft 314, which may be generally cylindrical in nature. The motor shaft 314 can extend longitudinally through a center of the rotor core 312. The motor shaft 314 may rotate with the rotor core 312 to provide the vehicle or other apparatus with mechanical power. Coupled to the motor shaft 314 is a cross sectional view of a bearing system 321. The bearing system 321 in this configuration includes an inner race 317a and 317b. The inner race 317a-b may be coupled to the motor shaft. Thus, the inner race 317a-b may rotate with the inner shaft. The bearing system 321 may further include bearings 308. Although two bearings 308 are illustrated in FIG. 3, the bearings may extend across the circumference of the bearing system 321 that houses the motor shaft 314. The bearings 308 may include or employ another existing configuration for facilitating motor shaft 314 rotation. For example, the bearings may be ball bearings, a shaft bearing, a sleeve bearing, or another type of bearing.

The bearing system 321 is shown as a cross-section of a circular surface. The bearing system 321 may further include an outer race 316a and 316b. The outer race 316a-b may be coupled to a first inner surface 369 of the drive unit case 370. In other implementations, the outer race 316a-b may be coupled indirectly to the drive unit case 370. In still other implementations, the bearing system 321 may be connected to another rigid or sturdy surface relative to the motor 300. In general, the outer race 316a-b may in practice be part of a single, integrated member that is circumferentially disposed around the case 370 to align with the bearings 308, and in turn the inner race 317a-b. The bearings 308 may include ball bearings that further includes gaps 320 between the inner race 317a-b and further gaps 320 between outer race 316a-b. A film of an oil or lubricant may be present or otherwise suspended in the gaps 320 for facilitating low-friction rotation of the bearings relative to the inner race 317a-b and outer race 316a-b. The bearings 308 may sit within the film of oil or lubricant. The oil or lubricant facilitates the movement of the bearings 308. One function of the oil in gap 320 is to prevent the bearings 308 from direct contact with the inner race 317a-b or the outer race 316a-b. This configuration can help prevent the bearings 308 from wearing down prematurely. The bearing system 321 is designed to allow the motor shaft 314 to smoothly rotate to provide mechanical power to a transmission, or directly to the wheel of an electric vehicle.

In one example, the inner race 317a-b, being coupled to the motor shaft, can rotate at very high speeds depending on criteria like the frequency of AC current supplied to the motor windings. The outer race 316a-b may, as noted, be stationary around the periphery of the first inner surface 369 of the drive unit case 370. The outer race 316a-b and the gaps 320 filled with oil may enable the bearings 308 to spin at high speeds in a stable manner. The drive unit case 370 may have a circular surface, hexagonal, or similarly shaped first inner surface 369 extending circumferentially around the motor. In some embodiments this first inner surface 369 may only represent an inner portion of a larger case, or the geometry of the inner surface 369 may be different. All or a dedicated portion of this larger case or other geometry may function as a ground for various electronic components in the motor 300.

A variety of bearing types and geometries may exist, each of which are intended to be included within the scope of the present disclosure. For example, roller bearings may be used.

Referring still to FIG. 3, the electrical energy constantly input into the stator 310 may result in high electric fields. These electric fields tend to capacitively couple onto the rotor core 312. This charge buildup may be a result of a parasitic capacitance C1 developing between the stator 310 and the rotor core 312 across the gap 396. As noted, the stator 310 may be coupled to the first inner surface 369 of the drive unit case 370 on one circumferential side, and adjacent the gap 396 on the other side. The drive unit case 370 is grounded in this scenario. Thus, the generated parasitic capacitance across gap 396 and adjacent regions tends to cause an unintended buildup of electric charge 364 on the rotor. The capacitance C1 may ultimately cause the electric charge 364 on the rotor core 312 to build up to a point where it causes a current to flow from the rotor core 312 through the motor shaft 314 and inner race 317a-b. The current may be large enough to create an electric arc 327 across the gap that flows through the bearing and arcs through the outer race 316a-b to dissipate through the first inner surface of the drive unit case 370. This current is generally referred to as an Electric Discharge Machining (EDM) current. Even if the buildup of electric charge 364 results in a one-volt potential difference from the grounded drive unit case 370, at high loads the oil in the gap 320 is pressed so thin that an electric current can discharge across the bearings.

This well-understood EDM current is undesirable, because the resulting electrostatic discharge (ESD) cause arcs 327 across the bearings and can create pits and other geometrical anomalies in the bearings 308 and causes damage, resulting in premature wear on the bearings 308, which can result in failure of the electric motor. The higher the buildup of electric charge 364, the more damage that can result on the bearings 308 as metal elements from the bearings 308 can splatter across the surrounding portions of the inner and outer race surfaces.

In one attempt to obviate this problem as shown in FIG. 3, certain practitioners in the art have implemented a spring system. For example, with reference to FIG. 3, a first portion 304 of a conductive spring 302 is arranged on a radial portion of the motor shaft 314. A second portion 318 of the spring 302 is arranged to electrically connect to the second inner surface 379 of the drive unit case 370, e.g., via a conducting lubricant. The electrical resistance of the spring 302 may be chosen such that the electric charge buildup due to the parasitic capacitance C1 between the stator 310 and the rotor core 312 creates a current path that discharges through the spring 302 and to the grounded second inner surface 379.

The motor shaft 314 and rotor core 312 spin at a potentially very high speed because of the PIM 28. A significant problem with the above-described solution is that, instead of causing damage to the bearing system 321 by inducing electrical arcs 327 via conductive path 390, the spring 302 instead is designed to pass the current through the motor shaft via the spring 302 to the second inner surface 379 of the case 370. The unwanted electrical arcs 327 across the bearings can be avoided. A problem of potentially greater magnitude, however, is unintentionally created in the process. The radial load on the motor shaft caused by the constant spinning action of spring 302 may cause the motor shaft 314 to deteriorate. That is, the continued rotational force of the spring 302 asserts an undesirable radial load on the motor shaft 314. The inventors have observed this problem by identifying wear in the motor shaft 314 of various existing motors, such as that shown by the wear line 306 in FIG. 3. This wear manifests initially in the form of a groove across a diameter of the motor shaft 314. Over a relatively short period of time, the groove can worsen spreading debris in the bearing system 321.

As with the example of FIG. 3 described above, the motor 200 in FIG. 2 relies on the spring 202 to maintain a low resistance electrical path to ground, to bypass arcs that can otherwise cause pits and other geometric deformations in the bearings. In so doing, the spring instead can inadvertently assert a radial-directed force on the motor shaft 314, resulting in likely future damage to the motor shaft 314.

Accordingly, in various aspects of the disclosure to mitigate or altogether obviate the above shortcomings, a grounding brush having an elliptical surface is configured to couple to a generally central axial portion of the motor shaft at one end. The grounding brush has another generally opposing surface configured to connect to a spring at another end. The spring has a first portion coupled to the opposing surface of the grounding brush and a second portion designed to apply a force to maintain a firm contact with an adjacent inner conducting surface of the case (or with a similar vehicle or system ground). The grounding brush in this implementation beneficially significantly reduces, and in some cases avoids altogether, placing an undesirable radial load on the motor shaft as in prior attempted solutions. At the same time, the grounding brush can be tuned geometrically and using appropriate material s/alloys to provide the requisite low resistance path to system ground whenever a buildup of electrical charge occurs on the rotor core. The grounding brush is part of an anti-arc system along with the spring that applies a force against the grounded case. This configuration in turn provides the suitable current flow to maintain the grounded case at an equal potential across the ground.

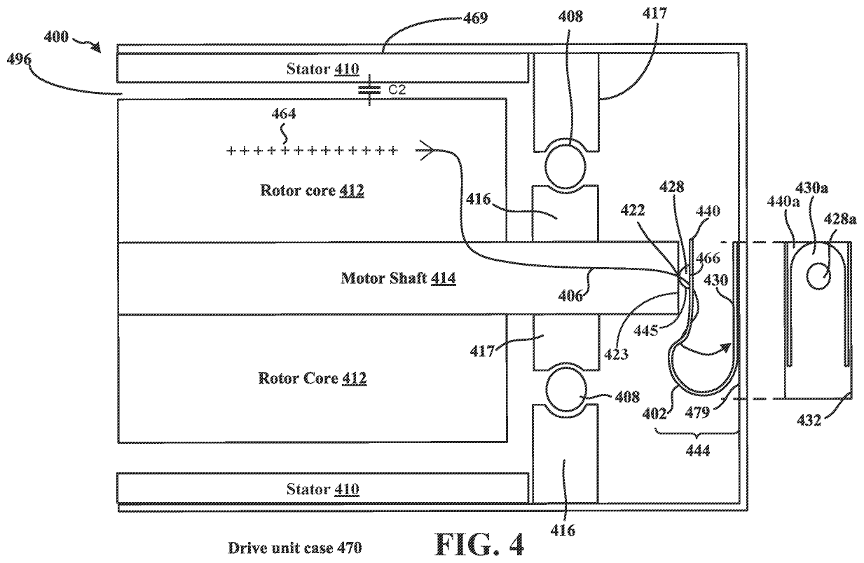

FIG. 4 is a side, cross-sectional illustration of an example electric motor 400 having a partly elliptical-shaped grounding brush 428 used for coupling a spring 402 to an axial portion 422 of the motor shaft 414 and having an elliptical shape to restrict or eliminate radial forces on the motor shaft 414. Opposing the elliptical shape of the grounding brush 428 is an outer surface 466 of the grounding brush 428, which can be seen as the vertical portion of the grounding brush 428 making contact with a first portion 440 of a spring 402, where the first portion 440 is also shown as contacting the outer surface 466 at a short vertical length as detailed in the illustration and as described in greater detail below. The first portion 440 makes contact with the outer surface 466 of the grounding brush via their respective surfaces. The outer surface 466 may be adhered to the first portion 440 of the spring using any conventional technique. In some embodiments, the outer surface 446 may instead be in electrical contact with the first portion 440 of the spring 402 via a conductive lubricant in a manner that enables the spring to remain stationary as the motor shaft 414 and grounding brush 428 rotate.

As in FIG. 3, the electric field on the stator 410 peripherally arranged within a first inner wall 469 of a drive unit case 470 of the electric motor 400 can cause a buildup of electric charge 464 on the rotor core 412 due to a parasitic capacitance C2 between the stator 410 and rotor core 412, with the gap 496 therebetween acting as a dielectric. The combined grounding brush 428 and spring 402 can be positioned to maintain contact with a second inner surface 479 of the drive unit case 470 or other structure acting as a system or vehicle ground. In so doing, the grounding brush 428 can hold the motor shaft 414 at zero volts potential relative to the drive unit case 470. At least a portion of the drive unit case is conductive and includes a ground discharge path from the rotor to the case via a grounding brush, as described further below.

Thus, the grounding brush 428 in various embodiments can be connected at the elliptical or partly elliptical surface 445 to the axial portion 422 at the center of the motor shaft's end face 423 at axial portion 422, as shown, or as close to a “center” that minimizes a radial load on the motor shaft 414 if the geometry of the motor shaft is not quite cylindrical, or not concentric at its end face 423. The elliptical surface 445 of the grounding brush 428 can oppose an outer surface 466, the latter of which can be connected to a first portion 440 of the spring 402. As generally shown by directional arrow 406, the spring 402 can be extended and curved so that a second portion 430 of the spring 402 can align generally flush with a second inner surface 479 of the drive unit case 470 to thereby apply a force via the second portion 430 of the spring 402 to the second inner surface 479 of the drive unit case 470 using a screw or other fastener (not shown). The combination of the grounding brush 428 and its respective surface, the spring 402 and its two portions, and the second inner surface 479 of the drive unit case 470 can be implemented as an effective anti-arc system 444. The combined current path from the rotor core 412 through the anti-arc system 444 to the ground of the second inner surface 479 (or in other embodiments, to another system ground) can be designed to have a lower electrical resistance across the range of motor speeds than a current flow leading to an electrical arc across the bearings 408. That is, the resistance can be chosen in a manner that ensures that accumulated electric charge 464 can be effectively discharged via the current path 406, and not through the inner race 416 (and therefore across the bearings, as also shown in FIG. 3).

In the embodiment shown, the grounding brush 428 has an elliptical surface 445, most easily seen in the cutaway view of the motor as a “half-ellipse” or “half-sphere” that can be symmetrically arranged at the axial portion 422 of the motor shaft 414. The point 422 of contact between the axial portion 422 and the grounding brush 428 can be large enough to maintain electrical contact along with the low electrical resistance, but small enough to minimize, if not substantially eliminate, an appreciable radial load on the motor shaft 414 or its orthogonal end face 423 such as shown in FIGS. 2 and 3. As a result, even in embodiments where the spring 402 (or the motor shaft 414) is rotating at high speeds, the structure of the motor shaft 414 is not compromised by a large radial load. In some embodiments, the spring maintains electrical contact with the outer surface without the spring itself rotating, such as where an electrically conductive lubricant is used between the spring and grounding brush 428 or between the grounding brush 428 and the axial portion 422 of the motor shaft 414. Further, the grounding brush 428 can be made of a solid, durable, very low resistance material which in these embodiments faces the motor shaft in a generally concentric manner. The opposing, flat outer surface 466 of the grounding brush 428 can be placed at an optimal location relative to the first portion 440 of the spring 402 such that when rotating, the spring 402 minimizes the stress on the grounding brush 428, e.g., caused by the centripetal force of the spring 402 in embodiments where it rotates. The constant torque on the motor shaft 414 by virtue of the radial loads as in FIGS. 2 and 3 is consequently substantially eliminated by the anti-arc system 444 shown in FIG. 4.

To the right of the second portion 430 of the spring 402, a face-on, top-down view 432 of key elements of the anti-arc system 444 is shown, with the elliptical portion 428a of the grounding brush 428 and the end face 423 of the motor shaft 414 omitted for clarity. In this embodiment, the first portion 440 of the spring 402 (transparent for illustrative purposes) is adhered, welded, or otherwise connected to the outer surface 466 of the grounding brush 428. In this top-down view 432, the first portion 440 wraps around to show a top-down view 432 of the spring (in which second portion 430a corresponds to the second portion 430 of the spring 402) that is shown transparently through the corresponding second portion 430a of the spring. The second portion 430a of the spring is pressed (using a force proportional to the spring constant k) against, or otherwise adhered to, the second inner surface 479 of the case. In sum, the anti-arc system 444, along with a subset 440a of its constituent parts, provides an effective, electrically conductive ground path without damaging or bending the motor shaft 414.

The grounding brush 428 may use different compositions. In various exemplary embodiments, for high wear resistance applications, the grounding brush may be composed of alloys such as, for example and without limitation, phosphor bronze, silicon bronze, brass, copper-nickel alloys, and other alloys or metals with similar properties. In some configurations, various Aluminum (Al) and steel alloys might be applicable as well.

In various embodiments, the grounding brush 428 may benefit from a high hardness material to meet a Rockwell Hardness of about 60 HRC for the shaft material. Additionally, the grounding brush may include a material that is more conductive than the steel used in the motor shaft and bearings (which may be about 6-7% IACS). One such example alloy is a C17200 alloy, which is a Be Cu alloy with both a high hardness and an electrical conductivity of 22-28% IACS.

While spring 402 is shown, practitioners in the art upon review of the present disclosure can appreciate that different embodiments and configurations of the spring 402 and other portions of the anti-arc system 444 are possible. For example, a different type of spring 402 can be used, or an element without a spring can be used, to provide a current path flow to any system ground that may be shared with stator 410 to ensure that the electric charge buildup due to C2 is discharged. Other implementations of such a spring or other conductive element to the case or another system ground is deemed to fall within the scope of the present disclosure where the predominant load on the motor shaft is axial in nature.

As another example, it will be appreciated that, while the axial end face or end face 423 of the motor shaft 414 can be circular, in some embodiments the axial end may be just partly circular, often depending on the remaining construction of the motor shaft 414. The axial end may be hexagonal or another partially symmetric shape, for example. The grounding brush 428 may be elliptical, or another shape. In the example shown, the grounding brush can be shaped as a portion of a sphere or 3-D ellipse, such as a hemisphere. In other embodiments, the elliptical surface may just be partly elliptical. For example, the elliptical surface may include a flat lip around its perimeter, e.g., for providing additional surface area when being adhered to the spring 402. Further, where the motor shaft 414 is uneven, the grounding brush 428 can be shaped differently to maintain an axial load on the motor shaft 414 while the spring 402 is rotating. Numerous other configurations can be contemplated that remain within the scope of the disclosure.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims. Moreover, this disclosure expressly includes combinations and sub-combinations of the elements and features presented above and below.

What is claimed:

1. An electric motor apparatus, comprising:
a case;
a stator arranged within a first inner surface of the case;
a rotor at least partly within the stator;
a motor shaft protruding longitudinally through the rotor to include an axial end;
a grounding brush having an outer surface opposing an at least partly elliptical surface; and
a spring comprising one portion to maintain electrical contact with a second inner surface of the case and another portion coupled to the outer surface of the brush, the at least partly elliptical surface attached to the axial end of the motor shaft to cause a current flow via the brush to the second inner surface of the case for discharging an electric charge buildup on the stator.

2. The apparatus of claim 1, wherein the electric charge buildup corresponds to a voltage induced by a parasitic capacitance between the rotor and the stator.

3. The apparatus of claim 1, further comprising a bearing system arranged peripherally between the case and the rotor, the bearing system including:
an outer race coupled to an interior of the case;
an inner race coupled to the motor shaft, and
at least one shaft or sleeve bearing, or other bearing type, positioned between the inner race and the outer race and configured to enable the inner race to rotate stably during rotation of the motor shaft.

4. The apparatus of claim 3, wherein at least a portion of the case is conductive and comprises a ground discharge path from the rotor to the case via the grounding brush.

5. The apparatus of claim 3, wherein the current flow prevents electrical arcs from damaging the bearing system during rotation of the motor shaft.

6. The apparatus of claim 3, wherein the current flow causes a voltage to equalize between the case, the stator and the bearing system.

7. The apparatus of claim 3, wherein an electrical resistance of a path from the rotor to the second inner surface of the case via the grounding brush and the spring is configured to be lower than an electrical resistance of a path from the rotor through the bearing system to the case.

8. The apparatus of claim 1, wherein the spring is configured to cause the grounding brush to assert an axial load on the motor shaft while minimizing a radial load on the motor shaft.

9. The apparatus of claim 1, wherein the grounding brush comprises a network of micro-carbon fibers.

10. The apparatus of claim 1, wherein the at least partly elliptical surface of the grounding brush is concentrically positioned relative to the center of the surface of the motor shaft.

11. The apparatus of claim 1, wherein the motor shaft is at least partly cylindrical and the outer surface of the motor shaft is concentric, a center portion of the concentric outer surface being attached to the at least partly elliptical surface of the grounding brush.

12. An electric motor for a vehicle, comprising:
a case;
a stator arranged within the case;
a rotor at least partly within the stator;
a motor shaft extending longitudinally through the rotor; and
an anti-arc system comprising a grounding brush and a spring, the spring having a first portion connected to the grounding brush and a second portion electrically contacting the case or another system ground, the grounding brush including an elliptical-shaped surface coupled outwardly to an axial end of the motor shaft to discharge an electric charge buildup on the rotor.

13. The electric motor of claim 12, wherein the electric charge buildup corresponds to a voltage induced by a parasitic capacitance between the motor shaft and the stator during rotation of the rotor.

14. The electric motor claim 13, further comprising at least one bearing arranged peripherally around the motor shaft and configured to enable the motor shaft to stably rotate.

15. The electric motor of claim 14, wherein the at least one bearing is secured by an inner race coupled to the motor shaft and an outer race coupled to an interior of the case.

16. The electric motor of claim 14, wherein the case comprises a system or vehicle electrical ground.

17. The electric motor of claim 14, wherein the discharge of the electric charge buildup causes the voltage to equalize between the case, the stator and the at least one bearing.

18. The electric motor of claim 12, wherein the spring is configured to cause the grounding brush to assert an axial load on the motor shaft while minimizing a radial load on the motor shaft.

19. The electric motor of claim 12, wherein the grounding brush comprises a network of micro-carbon fibers.

20. An electric motor, comprising:
a case;
a stator arranged within the case;
a rotor at least partly within the stator;
a motor shaft extending longitudinally through the rotor; and
an anti-arc system comprising a conducting grounding brush and a spring, the spring having a first portion connected to the grounding brush and a second portion configured to maintain contact with an interior of the case during motor operation,
wherein the grounding brush includes an elliptical-shaped surface having a center portion coupled outwardly to an axial end face of the motor shaft.
